(19) United States
(12) Patent Application Publication
(10) Pub. No.: US 2025/0343353 A1
(43) Pub. Date: Nov. 6, 2025

(54) RADIO FREQUENCY DEVICE AND COMMUNICATION DEVICE

(71) Applicant: HUAWEI TECHNOLOGIES CO., LTD., Shenzhen (CN)

(72) Inventors: Alejandro MURILLO BARRERA, Munich (DE); Grzegorz Wolosinski, Munich (DE); Bruno Biscontini, Munich (DE); Fabrizio Gentili, Munich (DE)

(21) Appl. No.: 19/271,521

(22) Filed: Jul. 16, 2025

Related U.S. Application Data
(63) Continuation of application No. PCT/EP2023/050797, filed on Jan. 16, 2023.

(51) Int. Cl. H01Q 3/36

(52) U.S. Cl. CPC H01Q 3/36

(57) ABSTRACT

A radio frequency, RF, device (1) comprising two or more sources (2), each source being configured to emit a RF wave (E), and a metasurface (3) configured to modulate the RF waves (E) emitted by the sources (2) so as to shift phase centers (5) of the sources (2) away from each other.

### CROSS-REFERENCE TO RELATED APPLICATIONS

This application is a continuation of International Application No. PCT/EP2023/050797, filed on Jan. 16, 2023, the disclosure of which is hereby incorporated by reference in its entirety.

### TECHNICAL FIELD

The present disclosure relates to a radio frequency device and a communication device.

### BACKGROUND

A radio frequency (RF) device for wireless communication may comprise or be connected to multiple sources (sources). Each source emits a radio frequency wave. A radio frequency wave is an electromagnetic wave with a frequency (or a range of frequencies) in the RF spectrum. The intensity of the RF wave at different directions (angles) from the source is referred to as the radiation pattern of the source.

### SUMMARY

In order to provide multiple independent information paths, a decorrelation of the radiation patterns (radiation pattern decorrelation) of the multiple sources may be implemented. Radiation pattern decorrelation may be achieved, for example, through at least one of the following: different polarizations of the sources (i.e. polarization diversity), different angular dependencies of the sources (i.e. distinct peak directions) and spatial displacements of the phase centers of the sources.

This disclosure aims to provide a RF device with two or more sources that has an improved performance, e.g. improved total throughput, or improved beam forming. The disclosure aims more specifically to provide an RF device with two or more sources that allows a decorrelation of the radiation patterns of the two or more sources.

These and other objectives are achieved by the solution defined by the independent claims. Advantageous implementations are further defined in the dependent claims.

A first aspect of this disclosure provides a radio frequency device comprising two or more sources and a metasurface. Each source is configured to emit an RF wave. The metasurface is configured to modulate the RF waves emitted by the sources so as to shift phase centers of the sources away from each other.

The metasurface thus enhances spatial decorrelation of the radiation patterns of the two or more sources. More specifically, the RF device can have a greater effective aperture and a greater directivity compared to a RF device that lacks the metasurface. The RF device will thus be more performant than a similar RF device that lacks the metasurface.

In one embodiment, the metasurface is arranged in a near field of the sources.

This allows the metasurface to be particularly effective.

In a further embodiment, the sources are arranged on a surface or on a line, and the metasurface extends parallel to the surface or the line.

This allows the metasurface to be simple yet effective.

In a further embodiment, the surface is a plane, or the line is an axis.

This allows the metasurface to be particularly simple yet effective.

In a further embodiment, the sources are arranged on the line, and the metasurface is configured to shift the phase centers of the sources away from each other along the line.

This allows the metasurface to be particularly simple yet effective.

In a further embodiment, the metasurface comprises one or more layers.

This allows the metasurface to be implemented economically.

In a further embodiment, each layer of the one or more layers comprises a set of cells, each cell having a reactance for a frequency of the RF waves.

This allows the metasurface to be implemented economically.

In a further embodiment, each respective source among the two or more sources has one of the cells arranged in front of the respective source.

This allows the metasurface to modulate the RF waves from the sources effectively.

In a further embodiment, the cells are arranged in a one-dimensional or two-dimensional lattice.

This allows the metasurface and the entire RF device to be compact yet performant.

In a further embodiment, the cells are adjoining.

This allows the metasurface and the entire RF device to be compact yet performant.

In a further embodiment, the set of cells includes a first cell and a second cell adjacent to the first cell, wherein the reactance of the second cell differs from the reactance of the first cell.

This allows the metasurface to be implemented with a minimum number of cells (while satisfying a given performance requirement).

In a further embodiment, the one or more layers comprise a first layer and a second layer, wherein the first layer comprises a first cell, the second layer comprises a second cell located in front of the first cell or behind the first cell, and the reactance of the second cell differs from the reactance of the first cell.

In the region of the first cell and the second cell, the reactance of the metasurface thus has a gradient in the propagation direction.

This allows the metasurface to be particularly effective.

In a further embodiment, the reactances are capacitive reactances.

This allows the metasurface to be implemented in an economic manner.

In a further embodiment, the set of cells comprises an inner cell and two outer cells and the reactances of the cells increase in magnitude from the inner cell to both outer cells.

This allows the metasurface to be particularly effective.

In a further embodiment, the inner cell is located at a midpoint of the set of cells.

This allows the metasurface to be particularly effective.

In a further embodiment, the reactances are symmetric in magnitude with respect to the inner cell.

This allows the metasurface to be particularly effective.

In a further embodiment, the sources are one of the following: antennas; and output ports of a waveguide structure. The antennas may, for example, be dual-polarized dipoles. The waveguide structure may be any kind of structure for feeding an RF wave, or multiple RF waves, from e.g. an antenna or an antenna array, toward the metasurface.

In a further embodiment, the antennas are dual-polarized antennas, e.g. dual-polarized dipoles.

This allows the RF device to be have a high information throughput.

A second aspect of this disclosure provides a communication device. The communication device comprises a RF device of the kind described above.

Thus a communication device with improved spatial diversity, e.g. improved beamforming characteristics, is provided.

The sources (or at least some of them) may differ from each other in their polarization and/or angular dependency.

The reactances of the cells in each layer of the metasurface may be designed according to one or more known design methods. For example, desired phase transformation may be converted into impedances, e.g. reactances, so that the sequence of cells is configured to act as reactances. Thus, the sequence of cells of each layer of the metasurface may be designed so that the sequence of cells is configured to act as reactances such that phase centers of the two or more sources are displaced in a direction of the sequence of cells. Thus, the sequence of cells of each layer is configured to achieve a modification of the phase centers of the two or more sources over the radiating aperture of the RF device.

The metasurface may be a thin sheet. For example, the metasurface may have a thickness less than a wavelength of the RF wave from the sources. The metasurface may comprise patterns of scatterers that are superimposed on the metasurface. The scatterers may be for example printed shapes of conductive material. The patterns of scatterers may be configured to alter RF waves that interact with the surface, such as the RF waves that may be emitted by the two or more sources through the metasurface.

Since the metasurface may comprise more than one layer, the metasurface may also be referred to as “metasurface structure”. The metasurface may comprise three or more layers for achieving an arbitrary phase delay and no wave reflection of the RF waves that may be emitted by the two or more sources. This may also be achieved by the metasurface comprising two layers. Optionally, the metasurface may comprise one layer. The metasurface may optionally comprise more than three layers. In this case a phase transformation of the RF waves that may be emitted by the two or more sources or radiation may be divided in several stages. That is, the metasurface may comprise multiple layers such that a phase transformation of the RF waves that may be emitted by the two or more sources or radiation is divided in several stages.

A cell of the metasurface is a piece or segment of the metasurface. Each cell has a reactance value. Two cells of the sequence of cells may have different reactance values.

Each cell acts as a reactance to an RF wave passing through it. The reactance value may be different for different frequencies of the RF wave.

In an embodiment in which the metasurface comprise multiple layers (i.e. two or more layers), the layers may be stacked in a direction that is perpendicular to the direction of a sequence of cells of each layer of the two or more layers. For example, the sequence of cells of each layer may extend horizontally and, thus, the stack of the two or more layers may be a vertical stack.

The cells (which act as reactances) introduce more phase (i.e. add phase shift) to RF waves from the two or more sources. This increases a slope of the phase profile of the radiation pattern of each source of the two or more sources. As a result, the phase centers of the two or more sources are shifted away from each other, e.g. in a direction of the sequence of cells.

This results in greater decorrelation of the radiation patterns of the two or more sources, which will thus be able to provide higher performance (e.g. greater data throughput, i.e. greater data rate) in a multiple-input multiple-output (MIMO) system (when the RF device is a MIMO device) and potentially a higher directivity. Further, the greater decorrelation of the radiation patterns produces higher pairing (i.e. better exploitation of spatial resource, by serving more users at the same time and frequency).

The phase profile of the radiation pattern of a source is the phase of the electromagnetic field as a function of space. The phase profile that is of interest here may be limited to a segment defined e.g. on top of the radiating aperture of the source and parallel to such aperture. The electromagnetic field may be represented as a complex vector at each position in space, i.e. a vector whose components are complex numbers. A complex number may be described by its magnitude and its phase. From such electromagnetic field vector the polarization of interest may be considered for designing the metasurface.

In this disclosure, the phase center of a source means the apparent position of the source as perceived at a position far away from the source (i.e. at a position in the far field), as if the source was concentrated in a single point. The phase center of a source may be calculated from a section of the radiation pattern of the source, e.g. a section containing the solid angle of maximum radiation.

The sequence of cells extends along a line. The line may be a straight line.

The two or more sources may be arranged on a line, i.e. arranged as a sequence. The sources may also be referred to as “radiators” or “radiating sources”.

Optionally, the RF device may comprise a reflector (e.g. a reflective layer), wherein the reflective layer and the metasurface are arranged on two opposite sides of the two or more sources. Thus, the two or more sources are arranged between the metasurface and the reflective layer. The metasurface is arranged on a front side of the sources. The reflector is arranged on a backside of the sources. The reflector reflects RF waves from the sources back into the front direction. The RF device will thus emit mainly in the front direction.

In an implementation form of the first aspect, the sequence of cells is configured to act as reactances such that the distance between the phase centers of the two or more sources in the direction of the sequence of cells is increased.

In other words, each layer comprises at least a sequence of cells configured to act as reactances such that the distance between phase centers of the two or more sources in the direction of the sequence of cells is increased compared to a case where the metasurface is not present. Increasing the distance between the phase centers of the two or more sources produces a greater effective radiating aperture of the RF device.

In an implementation form of the first aspect, the cells act as capacitive reactances.

In other words, each cell of the sequence of cells is configured to act as a capacitive reactance (i.e. have a negative reactance value).

In an implementation form of the first aspect, the sequence of cells is configured such that, for a frequency of the RF waves emitted by the two or more sources, an absolute value of the reactance value of the cells decreases with each cell from at least one of the two cells arranged at the two ends of the sequence of cells to a cell arranged within the sequence of cells.

As said above, each cell acts as a capacitive reactance, i.e. has a negative reactance value. The smaller the capacitive reactance is in magnitude, the greater is the phase shift of the RF wave that traverses the cell, and vice versa, for any given spectral component of the RF wave (i.e. for any given frequency of interest). That is, the smaller the magnitude of the reactance value, the more phase is introduced to the RF wave.

That is, the sequence of cells may be configured such that, for each frequency of a range of frequencies, the absolute value of the reactance value of the cells decreases with each cell from at least one of the two cells arranged at the two ends of the sequence of cells to a cell arranged within the sequence of cells. The term “bandwidth of frequencies” may be used as a synonym for the term “range of frequencies”.

Thus the sequence of cells may be configured to progressively introduce more phase to the RF waves that traverse the metasurface, more phase being introduced at the center of the sequence and less phase being introduced toward the two ends of the sequence.

In an implementation form of the first aspect, the sequence of cells is configured such that, for a frequency of the RF waves emitted by the two or more sources, an absolute value of the reactance value of the cells decreases with each cell from at least one of the two cells arranged at the two ends of the sequence of cells to a cell arranged at a midpoint of the sequence of cells.

In case the sequence of cells comprises an uneven number of cells there is a single cell at the midpoint of the sequence of cells. In case, the sequence of cells comprises an even number of cells there are two cells at the midpoint of the sequence of cells. In this case, the sequence of cells may be configured such that, for a frequency of the RF waves emitted by the two or more sources, an absolute value of the reactance value of the cells decreases with each cell from at least one of the two cells arranged at the two ends of the sequence of cells to a respective cell (of the two cells) arranged at a midpoint of the sequence of cells. In other words, in this case the cell arranged at a midpoint may be a respective cell of the two cells at the midpoint. The aforementioned may be true in case the reactances, as which the sequence of cells is configured to act, are capacitive reactances.

That is, the sequence of cells may be configured such that, for each frequency of a range of frequencies, an absolute value of the reactance value of the cells decreases with each cell from at least one of the two cells arranged at the two ends of the sequence of cells to a cell (or respective cell) arranged at a midpoint of the sequence of cells.

In an implementation form of the first aspect, the sequence of cells is configured such that, for a frequency of the RF waves from by the two or more sources, an absolute value of the reactance value of the cells decreases with each cell from each of the two cells arranged at the two ends of the sequence of cells to a cell arranged at a midpoint of the sequence of cells.

In case, the sequence of cells comprises an uneven number of cells there is a single cell at the midpoint of the sequence of cells. In case, the sequence of cells comprises an even number of cells there are two cells at the midpoint of the sequence of cells. In this case, the sequence of cells may be configured such that, for a frequency of the RF waves from by the two or more sources, an absolute value of the reactance value of the cells decreases with each cell from each of the two cells arranged at the two ends of the sequence of cells to a respective cell (of the two cells) at a midpoint of the sequence of cells. In other words, in this case the cell arranged at a midpoint may be a respective cell of the two cells at the midpoint. The aforementioned may be true in case the reactances, as which the sequence of cells is configured to act, are capacitive reactances.

That is, the sequence of cells may be configured such that, for each frequency of a range of frequencies of the RF waves from the sources), an absolute value of the reactance value of the cells decreases with each cell from each of the two cells arranged at the two ends of the sequence of cells to a cell (or respective cell) arranged at a midpoint of the sequence of cells.

In an implementation form of the first aspect, the sequence of cells is configured such that, with regard to the reactance value, the cells are symmetric along the sequence of cells with regard to the midpoint of the sequence of cells.

That is, with regard to the reactance value, the cells of the sequence of cells may be specular with regard to the midpoint of the sequence of cells.

In an implementation form of the first aspect, the RF device is an antenna array comprising two or more antennas, and the two or more sources are the two or more antennas of the antenna array.

The antenna array may be a planar antenna array, wherein the two or more antennas may be arranged in a sequence.

In an implementation form of the first aspect, the two or more antennas are two or more dual-polarized antennas.

Each polarization allows an independent channel for sending information. Optionally, the polarizations of the two or more dual-polarized antennas are orthogonal (e.g. purely orthogonal) and may be maintained orthogonal (e.g. purely orthogonal) by the propagation channel. If the polarizations of the dual-polarized antennas are orthogonal and maintained orthogonal by the propagation channel, the capacity of sending information may be doubled.

In an implementation form of the first aspect, the RF device is an antenna, and the two or more sources are associated with a respective signal input port of two or more signal input ports of the antenna.

In an implementation form of the first aspect, the two or more sources are arranged as a sequence along the sequence of cells in the direction of the sequence of cells.

In an implementation form of the first aspect, the two or more sources are arranged along a line that is parallel to an axis of the sequence of cells in the direction of the sequence of cells. The axis of the sequence of cells may be a symmetry axis.

In an implementation form of the first aspect, the metasurface comprises two or more layers, each layer of the two or more layers comprises the sequence of cells configured to act as reactances such that phase centers of the two or more sources are displaced in a direction of the sequence of cells, and the layers are aligned to each other such that the sequences of cells of the layers are aligned to each other.

In an implementation form of the first aspect, for a frequency of the RF waves emitted by the two or more sources, the sequence of cells of at least one layer of the layers is configured to have different reactance values compared to reactance values of the sequence of cells of one or more other layers of the layers.

In an implementation form of the first aspect, the RF device is a multiple-input multiple-output (MIMO) RF device.

In order to achieve the RF device according to the first aspect of this disclosure, some or all of the implementation forms and optional features of the first aspect, as described above, may be combined with each other.

A second aspect of this disclosure provides a communication device comprising an RF device according to the first aspect, as described above.

The communication device may be configured to wirelessly communicate using the RF device. For example, the communication device may be configured to use the two or more sources of the RF device for transmitting and/or receiving, via the metasurface of the RF device, RF waves. This allows wireless communication using RF waves. The communication device may be a mobile device. The communication device may be a user device, such as a mobile phone, a computer, a tablet, a laptop etc.

The above description of the RF device according to the first aspect is correspondingly valid for the communication device according to the second aspect.

The communication device of the second aspect and its implementation forms and optional features achieve the same advantages as the RF device of the first aspect and its respective implementation forms and respective optional features.

All steps which are performed by the various entities described in the present application as well as the functionalities described to be performed by the various entities are intended to mean that the respective entity is configured to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an example of an RF device according to an embodiment of this disclosure.

FIG. 2 shows an example of a communication device according to an embodiment of this disclosure.

FIG. 3 shows an example of a cell of RF device according to an embodiment of this disclosure and reactance values that may be provided by the cell to an RF wave passing through the cell for different frequencies of the RF wave.

FIG. 4 shows a side view of an example of an RF device according to an embodiment of this disclosure and a distance indicator.

FIG. 5 shows a perspective view of the RF device of FIG. 4.

FIG. 6 shows a top view of the RF device of FIG. 4 and for a frequency examples of reactance values of reactances as which the cells of a layer of a metasurface of the RF device may act as.

FIG. 7 shows examples of phase profiles of the radiation pattern of a source of the RF device of FIG. 4 that is arranged between a distance of 0 and 125 mm of the distance indicator of FIG. 4, assuming a reactance value distribution of the sequence of cells of each layer of the metasurface according to the table on the right side of FIG. 6.

FIG. 8 shows examples of phase profiles of the radiation pattern of a source of the RF device of FIG. 4 that is arranged between a distance of 125 and 250 mm of the distance indicator of FIG. 4, assuming a reactance value distribution of the sequence of cells of each layer of the metasurface according to the table on the right side of FIG. 6.

FIG. 9 shows examples of phase centers of the sources of the RF device of FIG. 4, assuming a reactance value distribution of the sequence of cells of each layer of the metasurface according to the table on the right side of FIG. 6.

In the Figures corresponding elements may be labelled with the same reference sign.

### DETAILED DESCRIPTION OF EMBODIMENTS

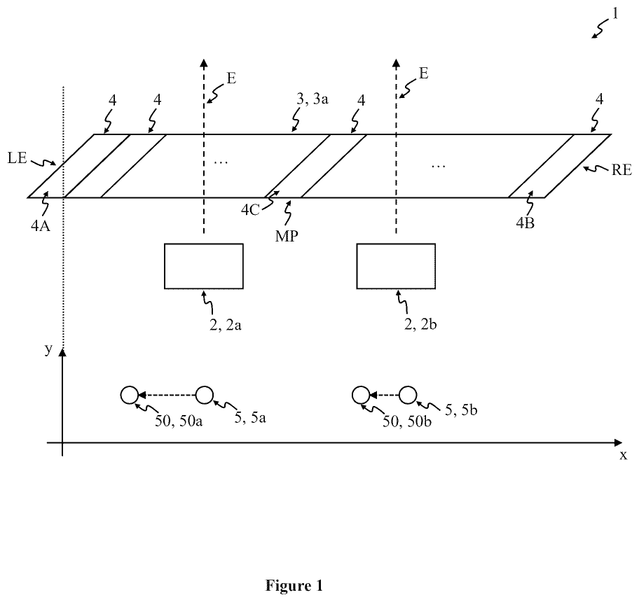

FIG. 1 shows an example of an RF device according to an embodiment of this disclosure. The RF device of FIG. 1 is an example of the RF device according to the first aspect of this disclosure. The description of the RF device according to the first aspect is correspondingly valid for the RF device of FIG. 1.

The RF device 1 of FIG. 1 comprises a metasurface 3 and two sources 2, namely the sources 2a and 2b. The number of source 2 shown in FIG. 1 is only by way of example and does not limit the present disclosure. That is, the RF device 1 may comprise more than two sources 2 (not shown in FIG. 1). In other words, the RF device may comprise two or more sources 2. According to the example FIG. 1, the metasurface 3 comprises a layer 3a. The present disclosure is not limited to this number of layers and, thus, the metasurface 3 may comprise more than one layer (not shown in FIG. 1). That is, the metasurface 3 may comprise one or more layers. For the following description, it is assumed that the RF device 1 comprise two sources 2a and 2b and the metasurface 3 comprises a layer 3a. The following description is correspondingly valid for the case that there are more than two sources 2 and/or the metasurface 3 comprises two or more layers.

The metasurface 3 is arranged in the near field of the two sources 2a and 2b such that RF waves E emitted by the two sources 2a and 2b are emitted through the metasurface 3. This is indicated in FIG. 1 by the dashed arrows that extend from the sources 2a and 2b through the metasurface 3. The layer 3a of the metasurface 3 comprises a sequence of cells 4 configured to act as reactances such that phase centers 5 of the two sources 2a and 2b are displaced in a direction of the sequence of cells 4.

The arrangement of the sources 2 with regard to the metasurface 3 shown in FIG. 1 is only schematic and is merely to indicate that the metasurface 3 is arranged in the near field of the sources 2 such that RF waves E emitted by the sources 2 are emitted through the metasurface 3. The RF waves E emitted by each source 2 may pass through the whole metasurface 3, i.e. through each cell 4 of the sequence of cells 4 of the layer 3a of the metasurface 3.

At the bottom of FIG. 1 an example of the spatial displacement of the phase centers 5 of the two sources 2a and 2b due to the presence of the metasurface 3 is shown. The y-axis indicates a first direction, e.g. vertical direction, which is perpendicular to the direction of the sequence of cells 4. The x-axis indicates a second direction, e.g. horizontal direction, which is perpendicular to the direction of the y-axis and, thus, equal to the direction of the sequence of cells 4. At the bottom of FIG. 1, the circle 5a represent the phase center of the source 2a (arranged in FIG. 1 on the left) and the circle 5b represent the phase center of the source 2b (arranged in FIG. 1 on the right) in case there is no metasurface 3 present (this case is not shown in FIG. 1). The circle 50a represent the phase center of the source 2a (arranged in FIG. 1 on the left) and the circle 50b represent the phase center of the source 2b (arranged in FIG. 1 on the right) in case the metasurface 3 is present (as shown in FIG. 1). As may be derived from the bottom of FIG. 1, for both sources 2a and 2b, the phase centers 5 of the two sources 2a and 2b are displaced in a direction of the sequence of cells 4, i.e. in the direction of the x-axis. Namely, as shown in FIG. 1, the phase center 5a of the source 2a in case of no metasurface 3 becomes the phase center 50a of the source 2a in case the metasurface 3 is present and the phase center 5b of the source 2b in case of no metasurface 3 becomes the phase center 50b of the source 2b in case the metasurface 3 is present.

The spatial displacement of the phase centers 5 of the sources 2 of the RF device may be controlled or set by the reactance values of the reactances, as which the sequence of cells 4 are configured to act. In other words, the spatial displacement of the phase centers 5 of the sources 2 of the RF device may be controlled or set by the reactance values of the reactances that may be generated by the sequence of cells 4.

According to the example displacement shown at the bottom of FIG. 1, the phase center 5a of the left source 2a is displace by a greater extend compared to the phase center 5b of the right source 2b. That is the distance between the phase center 5a of the left source 2a without metasurface 3 and the phase center 50a of the left source 2a when the metasurface 3 is present is greater than the distance between the phase center 5b of the right source 2b without metasurface 3 and the phase center 50b of the right source 2b when the metasurface 3 is present. As shown at the bottom of FIG. 1, the displacement of the phase centers of the two sources 2a and 2b occurs for both sources 2a and 2b to the left, i.e. the same direction being a direction of the sequence of cells 4.

For example, the displacement of the phase centers 5 of the sources 2a and 2a as shown at the bottom of FIG. 1 may be achieved by the following: The sequence of cells 4 are configured such that, for a frequency of the RF waves E emitted by the sources 2a and 2b, an absolute value of the reactance value of the cells 4 decreases with each unit from the cell 4A arranged at the left end LE of the sequence of cells 4 to the cell 4B arranged at the right end RE of the sequence of cells 4.

Namely, the smaller an absolute value of the reactance value of a cell for a frequency (i.e. a certain frequency) the greater the phase shift (i.e. the greater the absolute value of the phase shift) of RF waves having the frequency that imping on the cell and vice versa. That is, the smaller an absolute value of the reactance value of a cell for a frequency, the more phase is introduced to the RF waves having the frequency that imping on the cell. In other words, the smaller an absolute value of the reactance value of a cell for a frequency the less transparent is the cell for RF waves having the frequency and vice versa.

For example, for achieving a displacement of the phase centers 5 of the sources 2a and 2b to the right (i.e. in the opposite direction of the direction of displacement shown in FIG. 1), wherein the displacement of the phase center 5b of the right source 2b due to the metasurface 3 is greater than the displacement of the phase center 5a of the left source 2a due to the metasurface 3 (not shown in FIG. 1), the metasurface 3 may be designed such that the following is true: The sequence of cells 4 are configured such that, for a frequency of the RF waves E emitted by the sources 2a and 2b, an absolute value of the reactance value of the cells 4 decreases with each unit from the cell 4B arranged at the right end RE of the sequence of cells 4 to the cell 4A arranged at the left end LE of the sequence of cells 4.

For example, for achieving a displacement of the phase center 5a of the left source 2a to the left, i.e. in the direction of displacement shown in FIG. 1, and a displacement of the phase center 5b of the right source 2b to the right, i.e. in the opposite direction of the direction of displacement shown in FIG. 1, (not shown in FIG. 1) the metasurface 3 may be designed such that the following is true: The sequence of cells 4 are configured such that, for a frequency of the RF waves E emitted by the sources 2a and 2b, an absolute value of the reactance value of the cells 4 decreases with each unit from the cell 4A arranged at the left end LE of the sequence of cells 4 to a cell 4C arranged at a midpoint MP of the sequence of cells 4, and an absolute value of the reactance value of the cells 4 decreases with each unit from the cell 4B arranged at the right end RE of the sequence of cells 4 to the cell 4C arranged at the midpoint MP of the sequence of cells 4. In this case, the sequence of cells 4 may be configured such that, with regard to the reactance value, the cells 4 are symmetric along the sequence of cells 4 with regard to the midpoint MP of the sequence of cells 4. That is, with regard to the reactance value, the cells 4 of the sequence of cells 4 may be specular with regard to the midpoint MP of the sequence of cells 4. Optionally, the sources 2 may be symmetrically arranged with regard to the midpoint MP of the sequence of cells 4.

As shown in FIG. 1, the two sources 2 may be arranged along a line that is parallel to an axis of the sequence of cells 4 in the direction of the sequence of cells 4. The axis of the sequence of cells 4 may be a symmetry axis.

For further information on the RF device 1 of FIG. 1 reference is made to the description of the RF device according to the first aspect of this disclosure.

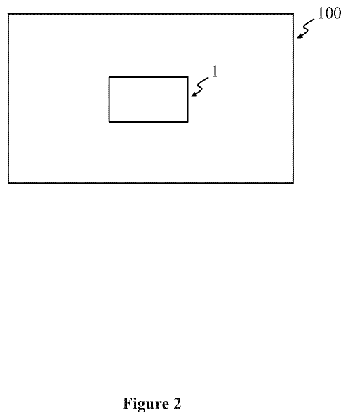

FIG. 2 shows an example of a communication device according to an embodiment of this disclosure. The communication device of FIG. 2 is an example of the communication device according to the second aspect of this disclosure. The description of the communication device according to the second aspect is correspondingly valid for the communication device of FIG. 2. As shown in FIG. 2, the communication device comprises an RF device 1 according to this disclosure. The RF device 1 may be the RF device of FIG. 1. The description of the RF device 1 of FIG. 1 is correspondingly valid for the RF device 1 of FIG. 2.

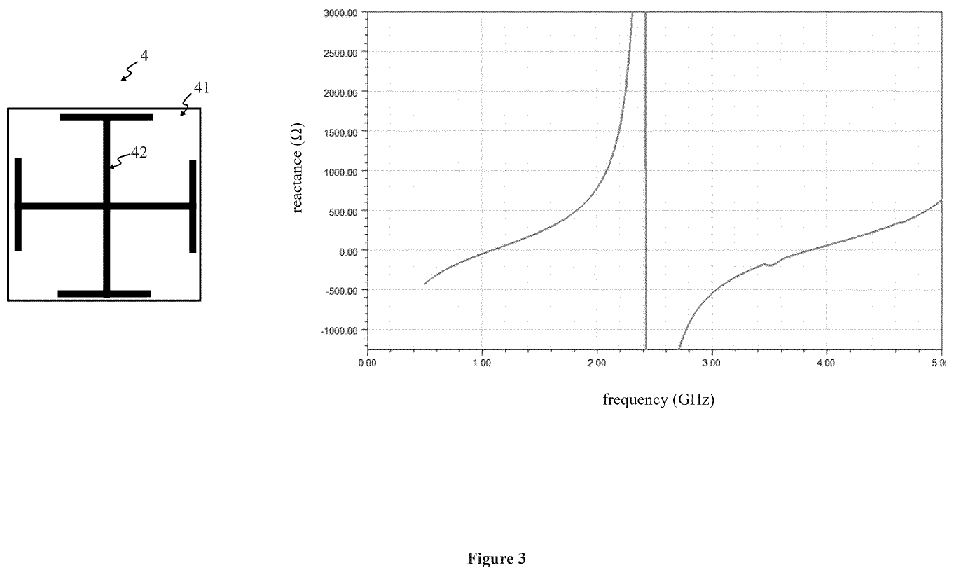

FIG. 3 shows an example of a cell of an RF device according to an embodiment of this disclosure and reactance values that may be provided by the cell to an RF wave passing through the cell for different frequencies of the RF wave.

As shown in FIG. 3, the cell 4 may comprise a substrate 41 and a conductive part 42 on the substrate 41. The conductive part 42 may have the form of a cross as shown in FIG. 3. The conductive part 42 may be printed on the substrate 41. That is, the cell 4 may be implemented for example as a printed conductive cross. The printed conductive cross 42 may comprise certain dimensions. The cell's 4 response, i.e. the impedance response of the cell 4, may be modified over frequency by changing the shape, i.e. the dimensions, of the conductive cross 42. The reactance is the imaginary part of the impedance. Thus, the conductive cross 42 allows the cell 4 to act as a reactance for the RF waves passing through the cell 4. The cell 4 comprising the conductive cross 42 may act as a capacitive reactance. That is the cell 4 may have a capacitive response.

As shown on the right side, the cell 4 (or a sequence of such cells) is configured to act as an impedance for RF waves passing through the cell 4, wherein a value of the impedance varies over the frequency of the RF waves. That is, the impedance has different values for different frequencies of the RF waves. The imaginary part of such impedance is the reactance. Thus, the cell 4 is configured to act as a reactance for the RF waves passing through the cell 4, wherein a value of the reactance varies over the frequency of the RF waves.

The variation of the value of the reactance over the frequency is exemplarily shown on the right side of FIG. 3, wherein the vertical axis indicates the reactance in Ohms ((2) and the horizontal axis indicates the frequency in gigahertz (GHz).

The cells 4 of the metasurface 3 of the RF device 1 of FIG. 1 may be designed to have a desired impedance response and, thus, reactance response, for a desired frequency or frequency range (i.e. at a design frequency or design frequency range). With other words, the cells 4 of the metasurface 3 of the RF device 1 may be designed to act as desired reactances for a frequency or frequency range of RF waves that may be emitted by the sources 2 of the RF device 1 and, thus, are intended to pass through the metasurface 3.

For this, one or more cells, optionally each cell, of the cells 4 of the metasurface 3 of the RF device 1 of FIG. 1 may be implemented as exemplarily shown on the left side of FIG. 3. That is, the one or more cells, optionally each cell, of the cells 4 of the metasurface 3 may comprise a conductive cross 42, which may optionally be a printed conductive cross.

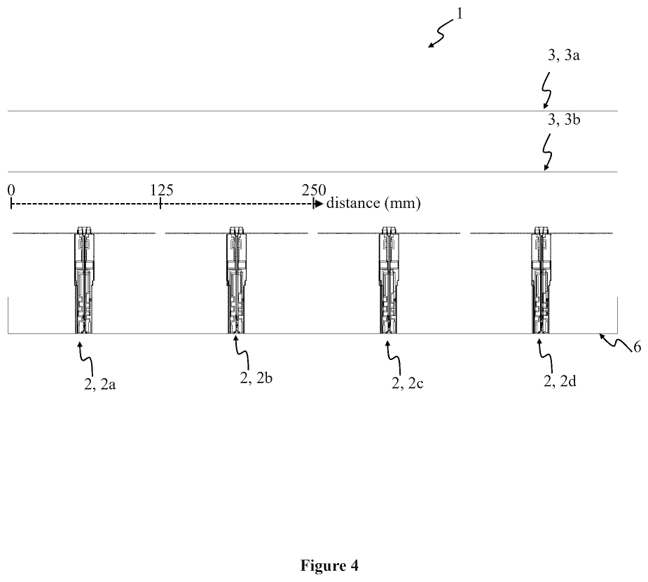

FIG. 4 shows a side view of an example of an RF device according to an embodiment of this disclosure and a distance indicator. The RF device 1 of FIG. 4 corresponds to the RF device 1 of FIG. 1, i.e. it is an optional implementation form of the RF device 1 of FIG. 1. Thus, the description of FIG. 1 is correspondingly valid for the RF device 1 of FIG. 4 and in the following mainly differences are described.

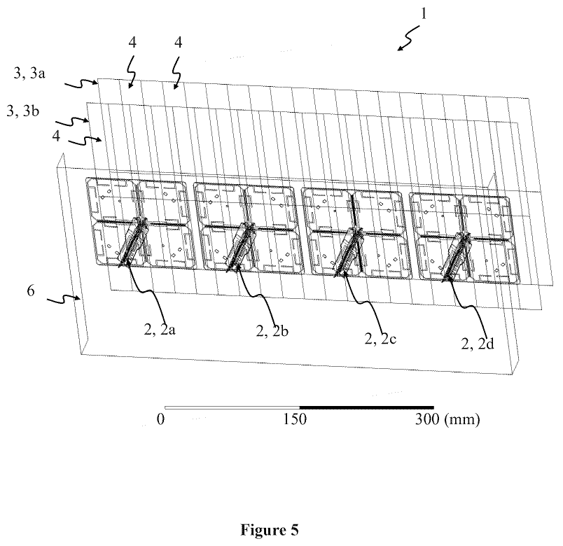

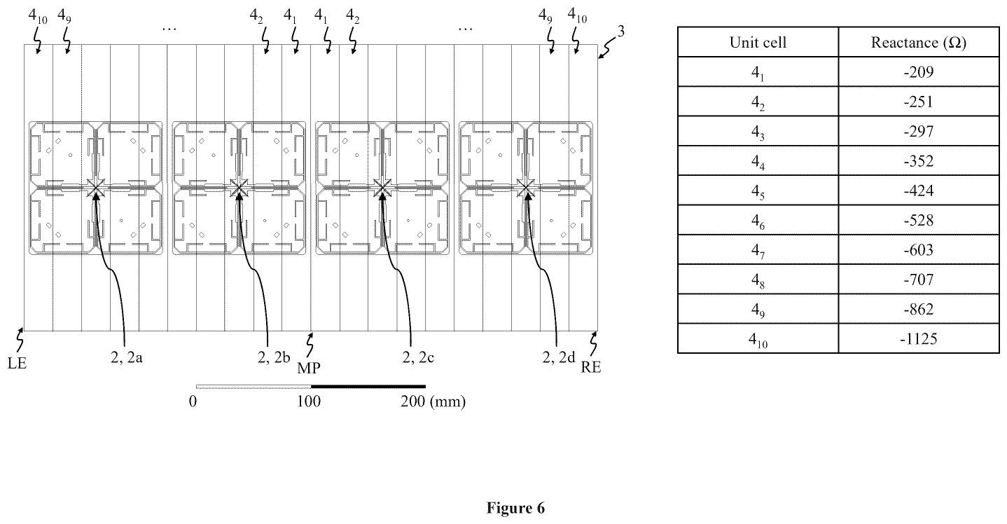

As shown in FIG. 4, the metasurface 3 comprises two layers 3a and 3b. Each of the two layers 3a and 3b comprises a sequence of cells 4 (not shown in FIG. 4) configured to act as reactances such that phase centers of the sources 2 of the RF device 1 are displaced in a direction of the sequence of cells 4. The sequence of cells 4 of the two layers 3a and 3b can be seen in FIGS. 5 and 6. The number of layers of the metasurface 3 of FIG. 4 is only by way of example and does not limit the present disclosure. Thus, the number of layers of the metasurface 3 may be one, as shown in FIG. 1, or greater than two. The description of the layer 3a of the metasurface 3 of the RF device 1 of FIG. 1 is correspondingly valid for each of the two layers 3a and 3b of the metasurface 3 of the RF device 1 of FIG. 4.

The RF device 1 of FIG. 4 comprises four sources 2a, 2b, 2c and 2d, wherein the metasurface 3 is arranged in the near field of the sources 2a, 2b, 2c and 2d such that the RF waves emitted by the sources 2a, 2b, 2c and 2d are emitted through the metasurface 3. The number of sources 2 of the RF device 1 of FIG. 4 is only by way of example and does not limit the present disclosure. Thus, the number of sources 2 may be two, as shown in FIG. 1, three or greater than four. The description of the sources 2 of the RF device 1 of FIG. 1 is correspondingly valid for each of the sources 2a, 2b, 2c and 2d of the RF device 1 of FIG. 4. The following description of the sources 2a, 2b, 2c and 2d of the RF device 1 of FIG. 4 is correspondingly valid for the sources in case the RF device comprises two, three or more than four sources. The sources 2 of the RF device 1 of FIG. 4 are dual-polarized radiators. Thus, according to FIG. 4, the RF device may comprise a radiating structure for emitting RF waves in the form of four dual-polarized radiators 2a, 2b, 2c and 2d, wherein a two layer metasurface 3 is arranged in the near field of the dual-polarized radiators 2a, 2b, 2c and 2d such that RF waves emitted by the dual-polarized radiators 2a, 2b, 2c and 2d pass through the metasurface 3. The type of sources 2 being dual-polarized radiators is only by way of example and does not limit this disclosure.

As shown in FIG. 4, the RF device 1 may comprise an optional reflective layer 6. This optional feature is independent on the number of layers of the metasurface 3 and the number of sources 2. That is, it may be optionally present regardless of the number of layers of the metasurface 3 and the number of sources 2. When the reflective layer 6 is present, the sources 2 are arranged between the reflective layer 6 and the metasurface 3. In other words, in the direction of emission of RF waves by the sources 2, the sources 2 are arranged between the metasurface 3 and the reflective layer 6. Thus, the metasurface 3 is arranged at a front side of the sources 2, at which the RF waves may be emitted by the sources 2. The optional reflective layer 6 may be arranged at the backside of the sources 2.

The reflective layer 6 allows improving the emission of the RF waves, which are emitted by the sources 2, through the metasurface 3, i.e. through the layers 3a and 3b of the metasurface 3.

In FIG. 4, a distance indicator is added that shows, in the direction of the sequence of cells 4 of each layer 3a and 3b of the metasurface 3, the distance from the left end of the metasurface 3 to a midpoint of the metasurface 3. Thus, the distance indicator shows the distance from the left end of the sequence of cells 4 of a respective layer of the metasurface 3 to a midpoint of the sequence of cells 4. The sources 2a, 2b, 2c and 2d are arranged such that the two sources 2a and 2b are positioned in the part of the metasurface 3 that is covered by the distance indicator.

In the example of FIG. 4, the two layers 3a and 3b of the metasurface 3 are identical. That is, the sequence of cells 4 of the layer 3a and the sequence of cells of the layer 3b is the same. This is only by way of example and may be different. That is, optionally, at least one cell of the sequence of cells of the layer 3a may be different to the corresponding cell of the sequence of cells of the layer 3b. For example, they may be different with regard to the reactance value. The layers 3a and 3b of the metasurface 3 may be aligned to each other such that the sequences of cells 4 of the layers 3a and 3b are aligned to each other.

As shown in FIG. 4, the layers 3a and 3b may be arranged above each other in a direction that is perpendicular to a direction of the sequence of cells 4 of each layer of the metasurface 3. In other words there may be an offset in the direction perpendicular to a direction of the sequence of cells 4 between the two layers 3a and 3b. In FIG. 4, the direction perpendicular to the direction of the sequence of cells 4 is the vertical direction. Thus, there is a vertical offset between the two layers 3a and 3b of the metasurface 3. The layers 3a and 3b of the metasurface 3 may be parallel to each other.

FIG. 5 shows a perspective view of the RF device of FIG. 4.

FIG. 6 shows a top view of the RF device of FIG. 4 and for a frequency examples of reactance values of reactances as which the cells of a layer of a metasurface of the RF device may act as. The implementation of the sources 2 of the RF device, as shown in the FIGS. 4 to 6 is only by way of example and may be differently. The description of FIG. 4 is correspondingly valid for FIGS. 5 and 6.

As indicated in FIG. 6, it is assumed that each layer of the metasurface 3 comprises a sequence of cells 4 that comprises 20 cells. This is merely by way of example and the number of cells 4 may be different. On the right side of FIG. 6 different reactance values are indicated that are introduced by the different cells 41 to 410. According to the example of FIG. 6, the sequence of cells 4 of each layer of the metasurface 3 is configured to act as capacitive reactances such that phase centers of the sources 2 are displaced in a direction of the sequence of cells 4. Since the cells may act as capacitive reactances, the different reactance values in the table on the right side of FIG. 6 are negative.

According to the example of FIG. 6, the absolute value of the reactance value (e.g. being 1125Ω) of the two cells 410 arranged at the two ends LE and RE of the sequence of cells 4 is the greatest value among the different reactance values of the cells of the sequence of cells 4. The absolute value of the reactance value (e.g. being 209Ω) of the two cells 41 arranged at the midpoint MP of the sequence of cells 4 is the smallest value among the different reactance values of the cells of the sequence of cells 4. As indicated in FIG. 6, the cells of the sequence of cells 4 are symmetric along the sequence of cells 4 with regard to the midpoint MP of the sequence of cells 4.

For example, according to FIG. 6, the sequence of cells 4 may be configured such that, for a frequency of the RF waves emitted by the sources 2a, 2b, 2c and 2d, an absolute value of the reactance value of the cells decreases with each cell from each of the two cells 410 arranged at the two ends LE and RE of the sequence of cells 4 to a respective cell 41 arranged within the sequence of cells 4.

As shown in FIG. 6, the sequence of cells 4 may be configured such that, with regard to the reactance value, the cells are symmetric along the sequence of cells 4 with regard to the midpoint MP of the sequence of cells 4. In other words, the distribution of reactance values is specular with respect to the midpoint MP of the sequence of cells 4. Thus, the distribution of reactance values may be specular with respect to the center of the radiating aperture of the RF device 1 comprising the four sources 2a, 2b, 2c and 2d that are configured to emit RF waves through the metasurface 3. As outlined above, in the example of FIG. 6, cells configured to provide smaller absolute values of reactances are arranged towards the midpoint MP of the sequence of cells 4 (i.e. towards the center of the radiating aperture). They introduce a greater phase shift to RF waves (emitted by the sources 2) that pass through the metasurface 3. Further, in the example of FIG. 6, cells configured to provide greater absolute values of reactances are arranged towards the two ends LE and RE of the sequence of cells 4 (i.e. towards the ends of the radiating aperture). They introduce a smaller phase shift to the RF waves (emitted by the sources 2) that pass through the metasurface 3. For example, the reactance value of e.g. −1125 (2 that may be provided by the cells 410 (edge cells) at the two ends of the sequence of cells 4 is almost transparent to the RF waves (emitted by the sources 2) that pass through the metasurface 3.

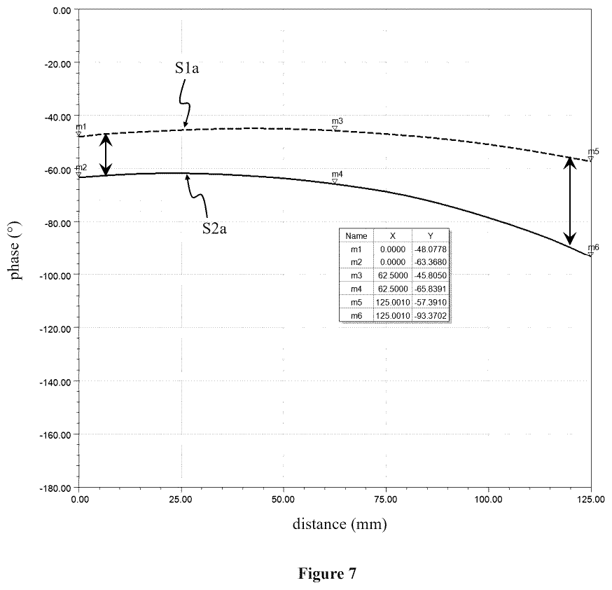

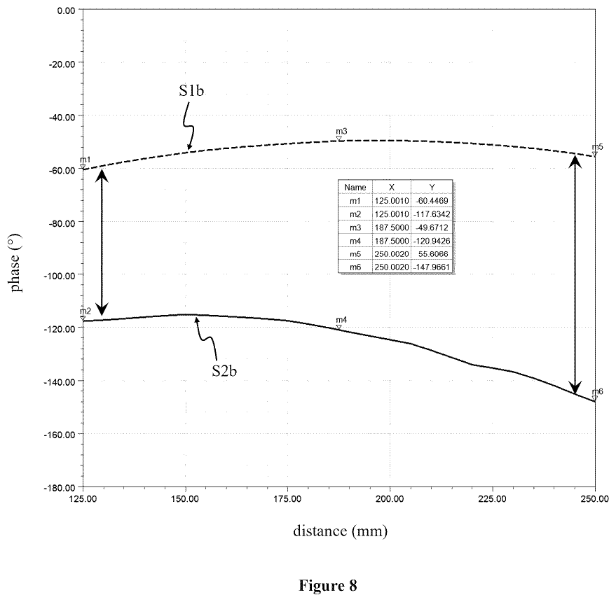

FIG. 7 shows examples of phase profiles of the radiation pattern of a source 2a of the RF device 1 of FIG. 4 that is arranged between a distance of 0 and 125 mm of the distance indicator of FIG. 4, assuming a reactance value distribution of the sequence of cells 4 of each layer of the metasurface 3 according to the table on the right side of FIG. 6. In other words, FIG. 7 shows examples of phase profiles of the radiation pattern of the source 2a, which is the most left source in the FIGS. 4 to 6. In FIG. 7, the phase profile (shown as dashed curve) of the radiation pattern of the source 2a when assuming that the metasurface 3 is not present is labelled by the reference sign “Sla”; and the phase profile (shown as solid curve) of the radiation pattern of the source 2 when assuming that the metasurface 3 having the reactance value distribution of the table of FIG. 6 is present is labelled with the reference sign “S2a”. FIG. 8 shows examples of phase profiles of the radiation pattern of a source 2b of the RF device 1 of FIG. 4 that is arranged between a distance of 125 and 250 mm of the distance indicator of FIG. 4, assuming a reactance value distribution of the sequence of cells 4 of each layer of the metasurface 3 according to the table on the right side of FIG. 6. In other words, FIG. 8 shows examples of phase profiles of the radiation pattern of the source 2b, which is the left source next to the center of the radiating aperture in the FIGS. 4 to 6. In FIG. 8, the phase profile of the radiation pattern (shown as dashed curve) of the source 2b when assuming that the metasurface 3 is not present is labelled by the reference sign “S1b”; and the phase profile of the radiation pattern of the source 2b when assuming that the metasurface 3 having the reactance value distribution of the table of FIG. 6 is present is labelled with the reference sign “S2b”.

In the graphs of FIGS. 7 and 8, the vertical axis indicates the phase in degree) (° and the horizontal axis indicates the distance in millimeters (mm) on the distance indicator shown in FIG. 4. Thus, as shown in FIGS. 7 and 8, the phase profile of the radiation pattern of a source (which is the source 2a in case of FIG. 7 and the source 2b in case of FIG. 8) may be understood as the curve of the phase of the electromagnetic field of the radiation pattern when plotted versus the position in space, for a segment defined e.g. on top of the radiating aperture of the source and parallel to such aperture.

As illustrated in FIGS. 7 and 8, each cell of the sequence of cells 4 introduces a phase shifts to the two RF waves that are emitted by the two sources 2a and 2b and that traverse the metasurface 3: a phase shift of the wave emitted by the source 2a and a phase shift of the wave emitted by the source 2b. The smaller an absolute value of the reactance value of a cell for a given frequency, the greater the phase shift (i.e. the greater the absolute value of the phase shift), and vice versa. The reactance values are distributed according to the table of FIG. 6. Thus a smaller phase shift is introduced by the metasurface 3 near the distance 0 mm compared to the phase shift that is introduced by the metasurface 3 near the distance 125 mm (cf. FIG. 7) and a smaller phase shift is introduced by the metasurface 3 near the distance 125 mm compared to the phase shift that is introduced by the metasurface 3 near the distance 250 mm.

For example, as shown in FIG. 7, the phase of RF wave emitted by the source 2a at a distance of 0 mm of the distance indicator of FIG. 4 when there is no metasurface 3 is shifted from −48.0778° to −63.3680° when the metasurface 3 is present, which corresponds to a phase shift of about 15° that is caused by the metasurface 3 at the distance of 0 mm. Further, as shown in FIG. 7, the phase of RF waves emitted by the source 2a at a distance of 125 mm of the distance indicator of FIG. 4 when there is no metasurface 3 is shifted from −57.3910° to −93.3702° when the metasurface 3 is present, which corresponds to a phase shift of about 36° that is caused by the metasurface 3 at the distance of 125 mm. Further, as shown in FIG. 8, the phase of RF waves emitted by the source 2b at a distance of 125 mm of the distance indicator of FIG. 4 when there is no metasurface 3 is shifted from −60.4469° to −117.6342° when the metasurface 3 is present, which corresponds to a phase shift of about 57° that is caused by the metasurface 3 at the distance of 125 mm. Further, as shown in FIG. 8, the phase of RF waves emitted by the source 2b at a distance of 250 mm of the distance indicator of FIG. 4 when there is no metasurface 3 is shifted from −55.6066° to −147.9661° when the metasurface 3 is present, which corresponds to a phase shift of about 92° that is caused by the metasurface 3 at the distance of 250 mm.

Thus, FIGS. 7 and 8 show that the smaller the absolute value of the reactance value introduced by the sequence of cells 4 the greater the phase shift (i.e. the greater the absolute value of the phase shift) that is introduced by the metasurface 3 to RF waves emitted by the sources 2a and 2b through the metasurface 3. As may be gathered from FIGS. 7 and 8, introducing negative phase shift to the RF waves makes the phase more negative. Since the phase slopes Sla and Slb of the radiating sources 2a and 2b decrease towards the center of the radiating aperture of the RF device 1, the center being at a distance of 250 mm (see FIG. 4), introducing more phase shift towards the center of the radiating aperture implies increasing the slope. That is, in FIG. 7, the slope (i.e. rate of change) of the curve S2a is greater than the slope (i.e. rate of change) of the curve Sla, and, in FIG. 8, the slope of the curve S2b is greater than the slope of the curve Slb. For real radiating sources such slope is not a straight line (as shown in FIGS. 7 and 8). For certain theoretical (ideal) radiating sources, the slope of the phase profile may be represented by a straight line (not shown in FIGS. 7 and 8).

The phase shift caused by the metasurface 3 for RF waves emitted by the source 2a at a distance of 125 mm (as shown in FIG. 7) and the phase shift caused by the metasurface 3 for RF waves emitted by the source 2b at a distance of 125 mm (as shown in FIG. 8) may differ from each other due to differences between the sources 2a and 2b, e.g. differences in the emission characteristics and/or position of the sources 2a and 2b.

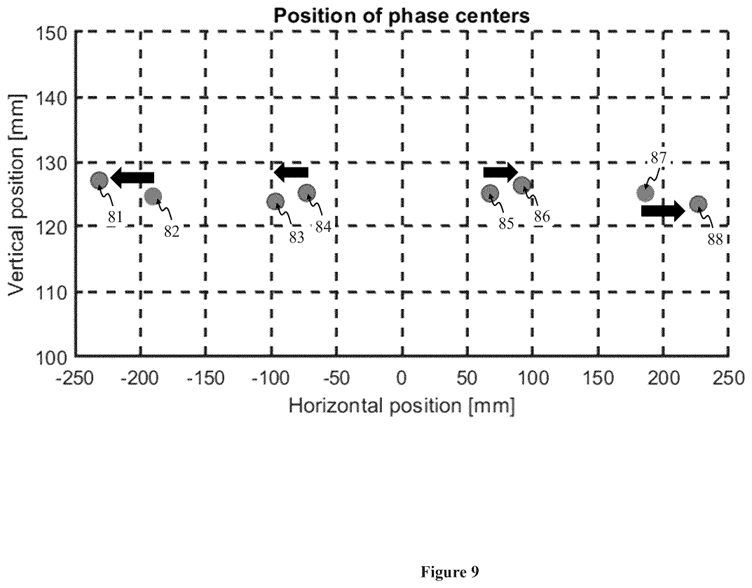

FIG. 9 shows examples of phase centers of the sources of the RF device of FIG. 4, assuming a reactance value distribution of the sequence of cells of each layer of the metasurface according to the table on the right side of FIG. 6. FIG. 9 shows the spatial displacement of the phase center of each of the four sources 2a, 2b, 2c and 2d of the RF device 1 of FIGS. 4 to 6, assuming that the reactances that may be provided by the cells of the sequence of cells 4 of each layer of the metasurface 3 have a reactance value distribution as outlined in the table of FIG. 6. For FIG. 9 it is assumed, that the origin of the coordinate system is arranged at the midpoint MP of the sequence of cells 4 and, thus, at the center of the radiating aperture of the RF device. Thus, at the origin of the coordinate system the cells 41 of the sequence of cells 4 have the smallest absolute value of reactance value among the reactance values of the sequence of cells 4 and at a distance of 250 mm to the left of the center (i.e. horizontal position of −250 mm) as well as at a distance of 250 mm to the right of the center (i.e. horizontal position of 250 mm) the corresponding cell 410 of the sequence of cells 4 has the greatest absolute value of reactance value among the reactance values of the sequence of cells 4. The horizontal axis of the coordinate system of FIG. 9 is in direction of the sequence of cells 4 of each layer of the metasurface 3 and the vertical axis of the coordinate system of FIG. 9 is perpendicular to the horizontal axis. In FIG. 9, the horizontal axis indicates the horizontal position in millimeters (mm) with regard to the origin of the coordinate system and the vertical axis indicates the vertical position in millimeters (mm) with regard to the origin of the coordinate system.

In case there is no metasurface 3 present, the phase center of the sources 2a, 2b, 2c and 2d of the RF device 1 of FIGS. 4 to 6 is represented by a circle labeled with the reference sign “82”, “84”, “85” and “87”, respectively. In case the metasurface 3 is present, the phase center of the sources 2a, 2b, 2c and 2d of the RF device 1 of FIGS. 4 to 6 is represented by a circle labeled with the reference sign “81”, “83”, “86” and “88”, respectively. Thus, FIG. 9 shows that the phase centers of the sources 2a, 2b, 2c and 2d of the RF device 1 of FIGS. 4 to 6 are spatially displaced in the direction of the sequence of cells 4 of each layer of the metasurface 3 (i.e. in the horizontal direction) due to the presence of the aforementioned metasurface 3. The spatial displacement shown in FIG. 9 of the phase centers is due to the reactance value distribution of the table of FIG. 6 for the reactances hat may be provided by the cells of the sequence of cells 4 of each layer of the metasurface 3.

As shown in FIG. 9, the sequence of cells 4 is configured to act as reactances such that (starting from the origin of the coordinate system), the distance between the phase centers of the sources in the direction of the sequence of cells is increased. Due to the reactance value distribution according to the table of FIG. 6, the spatial displacement of the phase center 82 of the source 2a caused by the metasurface 3 having the aforementioned reactance value distribution is greater than the spatial displacement of the phase center 84 of the source 2b caused by the metasurface 3 having the aforementioned reactance value distribution. Accordingly, the spatial displacement of the phase center 87 of the source 2d caused by the metasurface 3 having the aforementioned reactance value distribution is greater than the spatial displacement of the phase center 85 of the source 2c caused by the metasurface 3 having the aforementioned reactance value distribution. Due to the reactance value distribution according to the table of FIG. 6, i.e. due to the specular distribution with regard to the midpoint MP of the sequence of cells 4 of the metasurface, the phase centers 82 and 84 of the sources 2a and 2b, respectively, are displaced in the negative horizontal direction, and the phase centers 85 and 87 of the sources 2c and 2d, respectively, are displaced in the positive horizontal direction. The small vertical displacement of the phase centers 82, 84, 85 and 87 of the sources 2a, 2b, 2c and 2d, respectively, shown in FIG. 9, is negligible and, thus, may be disregarded.

As may be derived from FIG. 9, the effect of the metasurface 3 is that the phase centers 82, 84, 85 and 87 of the sources 2a, 2b, 2c and 2d, respectively, are spatially displaced outwards with regard to the center of the radiating aperture of the RF device (i.e. origin of the coordinate system of FIG. 9). Thus, as shown in FIG. 9, the metasurface 3 allows increasing the distance between phase centers 82, 84, 85 and 87 of the sources 2a, 2b, 2c and 2d, respectively, in the direction of the sequence of cells 4. Therefore, the metasurface 3 allows achieving a decorrelation of the radiation patterns of the sources 2a, 2b, 2c and 2d.

This allows a greater number of degrees of freedom of the RF device 1. Further, this allows a greater separation of the sources 2a, 2b, 2c and 2d of the RF device 2, which leads to a greater effective aperture and a greater directivity of the RF device 1. As a result, the RF device 1 achieves a higher system performance (i.e. better system performance) compared to the case where the RF device 1 does not comprise the metasurface 3.

FIGS. 1 to 9 and corresponding paragraphs in the description can be easily adapted to the following: a number of layers of the metasurface different from the number(s) shown, a number of sources different from the number(s) shown, a number of cells different from the number shown, a different reactance value distribution of the sequence(s) of cells.

The present invention has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A radio frequency, RF, device (1), comprising:
two or more sources (2), each source being configured to emit a RF wave (E), and
a metasurface (3) configured to modulate the RF waves (E) emitted by the sources (2) so as to shift phase centers (5) of the sources (2) away from each other.

2. The RF device (1) of claim 1,
wherein the metasurface (3) is arranged in a near field of the sources (2).

3. The RF device (1) of claim 1,
wherein the sources (2) are arranged on a surface or on a line, and wherein the metasurface (3) extends parallel to the surface or the line.

4. The RF device (1) of claim 3,
wherein the surface is a plane, or wherein the line is an axis.

5. The RF device (1) of claim 3,
wherein the sources (2) are arranged on the line, and wherein the metasurface (3) is configured to shift the phase centers (5) of the sources away from each other along the line.

6. The RF device (1) of claim 3,
wherein the metasurface (3) comprises one or more layers (3a, 3b).

7. The RF device (1) of claim 6,
wherein each layer of the one or more layers (3a) comprises a set of cells (4), each cell having a reactance for a frequency of the RF waves (E).

8. The RF device (1) of claim 7,
wherein each respective source among the two or more sources (2) has one of the cells (4) arranged in front of the respective source.

9. The RF device (1) of claim 7,
wherein the cells (4) are arranged in a one-dimensional or two-dimensional lattice.

10. The RF device (1) of claim 7,
wherein the cells (4) are adjoining.

11. The RF device (1) of claim 7,
wherein the set of cells includes a first cell and a second cell adjacent to the first cell, wherein the reactance of the second cell differs from the reactance of the first cell.

12. The RF device (1) of claim 7,
wherein the one or more layers (3a, 3b) comprise a first layer (3a) and a second layer (3b), the first layer (3a) comprises a first cell, the second layer (3b) comprises a second cell located in front of the first cell or behind the first cell, and the reactance of the second cell differs from the reactance of the first cell.

13. The RF device (1) of claim 7,
wherein the reactances are capacitive reactances.

14. The RF device (1) of claim 7,
wherein the set of cells (4) comprises an inner cell and two outer cells and the reactances of the cells (4) increase in magnitude from the inner cell to both outer cells.

15. The RF device (1) of claim 14,
wherein the inner cell is located at a midpoint of the set of cells (4).

16. The RF device (1) according to claim 15,
wherein the reactances are symmetric in magnitude with respect to the inner cell.

17. The RF device (1) according to claim 1,
wherein the sources (2) are one of the following:
antennas; and
output ports of a waveguide structure.

18. The RF device (1) according to claim 17,
wherein the antennas are dual-polarized antennas.

19. A communication device (100) comprising a RF device (1), wherein the RF, device (1), comprises:
two or more sources (2), each source being configured to emit a RF wave (E), and
a metasurface (3) configured to modulate the RF waves (E) emitted by the sources (2) so as to shift phase centers (5) of the sources (2) away from each other.

20. The communication device of claim 1, wherein the metasurface (3) is arranged in a near field of the sources (2).
